(19) United States
(12) Patent Application Publication
(10) Pub. No.: US 2003/0006957 A1
(43) Pub. Date: Jan. 9, 2003

(54) Method and system for automatically covering video display of sensitive information

(76) Inventors: Victor Colantonio, Newton, MA (US); Julian L. Center JR., Andover, MA (US); Evgeniy Gusyatin, West Roxbury, MA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/012,098

(22) Filed: Nov. 13, 2001

Related U.S. Application Data
(60) Provisional application No. 60/247,145, filed on Nov. 10, 2000.

(51) Int. Cl. G09G 5/00

(52) U.S. Cl. 345/156

(57) ABSTRACT

A system and corresponding method for providing security against unwanted viewing of information being displayed on a video terminal of a computer workstation, the computer workstation including an input device such as a keyboard, the system including: a camera, responsive to the presence of any user of the computer workstation, the camera for providing from time to time a camera image suitable for indicating whether at the time a user is viewing the video terminal; a guard module, hosted by the workstation, responsive to the camera image, and further responsive to a notice of activity on an input device, the notice provided by the operating system of the workstation, for providing in pre-determined cases a command to the operating system to open a covering window and to display on the video terminal the covering window as the active window, the covering window of sufficient size to cover substantially all of the information bearing regions being displayed on the video terminal; wherein the pre-determined cases include a case in which the camera image indicates that no user is present at the workstation and there is no activity on any input device, and a case in which the camera image indicates that although a user is present at the workstation, the user is not looking at the video terminal, such as when a user has turned away from the video terminal to talk to a passerby, and there is no input activity.

### CROSS-REFERENCE TO RELATED APPLICATION

This non-provisional application claims the benefit of provisional application S. No. 60/247,145, filed Nov. 10, 2000.

### FIELD OF THE INVENTION

The present invention relates to providing security for information displayed on the video terminal of a computer. More particularly, the present invention concerns preventing unwanted viewing of a video terminal display of sensitive information, such as when a co-worker, unauthorized to have access to information being displayed on the video terminal of a computer work station, approaches the computer work station to ask a question or to invite the operator of the work station to lunch.

### BACKGROUND OF THE INVENTION

In many offices situations, an office worker working at a computer workstation views information displayed by the video terminal of the workstation that is some class of confidential information, such as private personnel information. A visitor, such as a worker in a nearby cubicle, may enter the work area of worker viewing such confidential information, and may see the confidential information. While it is generally possible for the worker using a windows-type operating system to close the window displaying the confidential information as soon as anyone enters the user's work area, doing so is awkward. The visitor entering the work area is often left with the belief that either the user who was viewing the confidential information was instead viewing something he or she should not have been viewing, or that the user viewing the confidential information believes that the visitor cannot be trusted. As a result, it is often the case that a worker will not close the window when doing so would be in any way obvious to a visitor, in order either to demonstrate to the visitor that the worker is making legitimate use of the workstation, or to demonstrate that the worker does indeed have confidence in the trustworthiness of the visitor.

What is needed is a system that will automatically and quickly conceal any information being displayed on the video terminal of a computer workstation whenever the user of the workstation stops using the computer workstation, such as when stopping to greet a visitor.

### SUMMARY OF THE INVENTION

Accordingly, the present invention is a system and corresponding method for providing security against unwanted viewing of information being displayed on a video terminal of a computer workstation, the computer workstation including an input device such as a keyboard, the system including: a camera, responsive to the presence of any user of the computer workstation, the camera for providing from time to time a camera image suitable for indicating whether at the time a user is viewing the video terminal; a guard module, hosted by the workstation, responsive to the camera image, and further responsive to a notice of activity on an input device, the notice provided by the operating system of the workstation, for providing in pre-determined cases a command to the operating system to open a covering window and to display on the video terminal the covering window as the active window, the covering window of sufficient size to cover substantially all of the information bearing regions being displayed on the video terminal; wherein the pre-determined cases include a case in which the camera image indicates that no user is present at the workstation and there is no activity on any input device, and a case in which the camera image indicates that although a user is present at the workstation, the user is not looking at the video terminal, such as when a user has turned away from the video terminal to talk to a passerby, and there is no input activity.

In a further aspect of the invention, the guard module includes: a detect any face module, responsive to the camera image, also responsive to detection algorithm parameters for indicating a threshold used to determine whether a user is viewing the video terminal, and further responsive to detection algorithm parameter, for determining whether a user is viewing the video terminal and for providing a corresponding indicator indicating whether a user is viewing the video terminal; a detect input device activity module, responsive to the notice of activity on an input device, for providing an indication of whether a user is using an input device; an adapt sensitivity control module, for adapting the detection algorithm parameters to conditions making detecting a face difficult, such as poor lighting conditions, responsive to the indicator indicating whether a user is viewing the video terminal, and further responsive to an indication from the detect any face module whether a user is viewing the video terminal, for providing detection algorithm parameters; and a control covering window module, responsive to the indicator indicating whether a user is viewing the video terminal, and further responsive to the indication of whether a user is using an input device, for providing the command to the operating system to open a covering window in case the system determines that no user is viewing the video terminal and no user is using an input device.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a guard system according to the present invention for providing covering window to obscure what is displayed by a video terminal of a workstation in case of a user not being present at the workstation, or turning away from the video display of the workstation and not using an input device; and

FIG. 2 is a state transition diagram indicating the operation of a guard system according to the present invention.

### BEST MODE FOR CARRYING OUT THE INVENTION

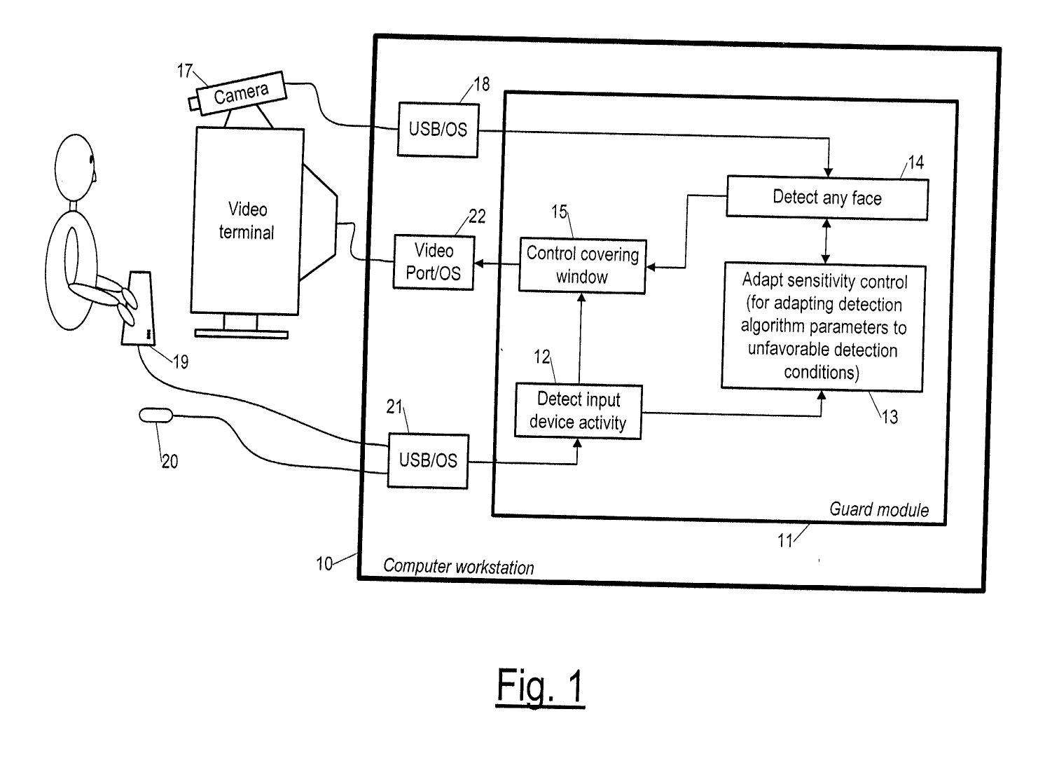

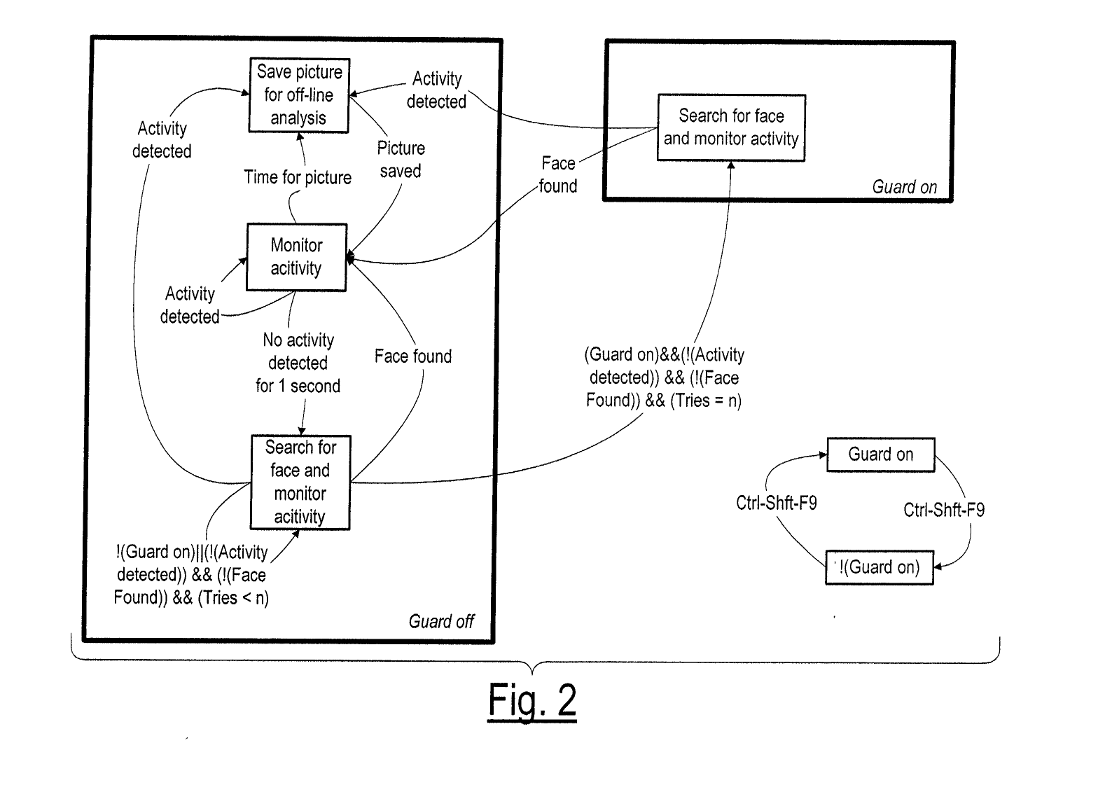

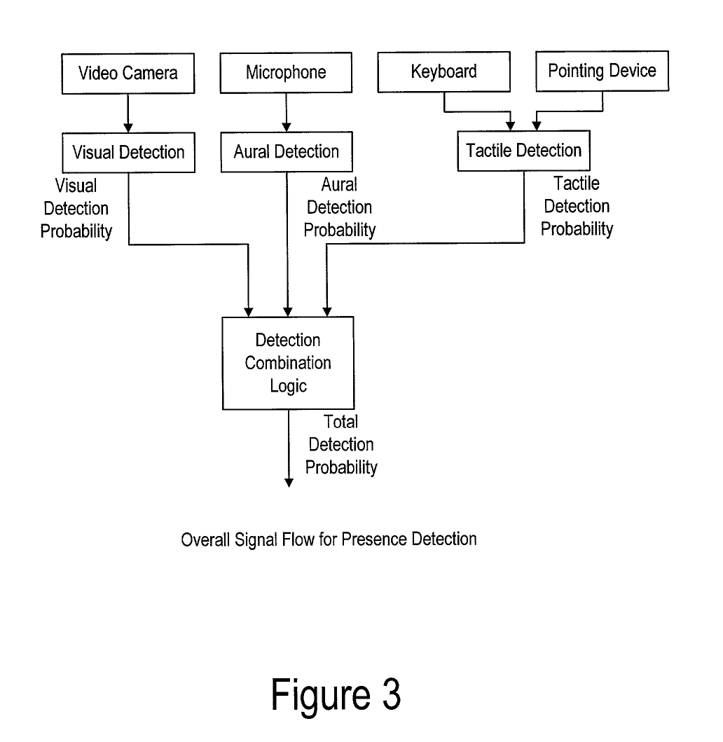

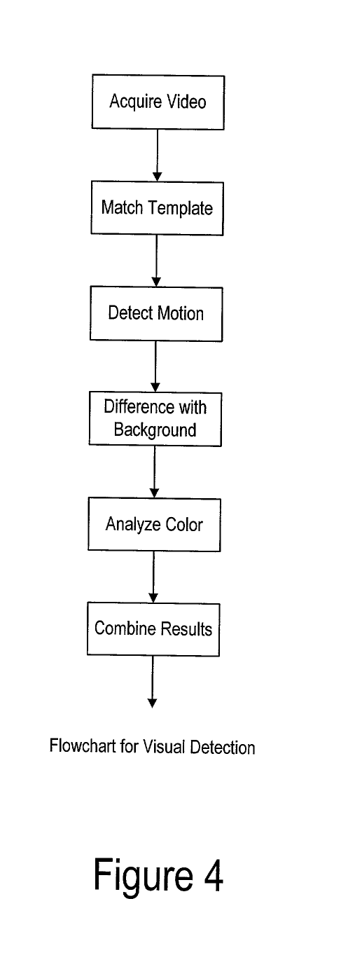

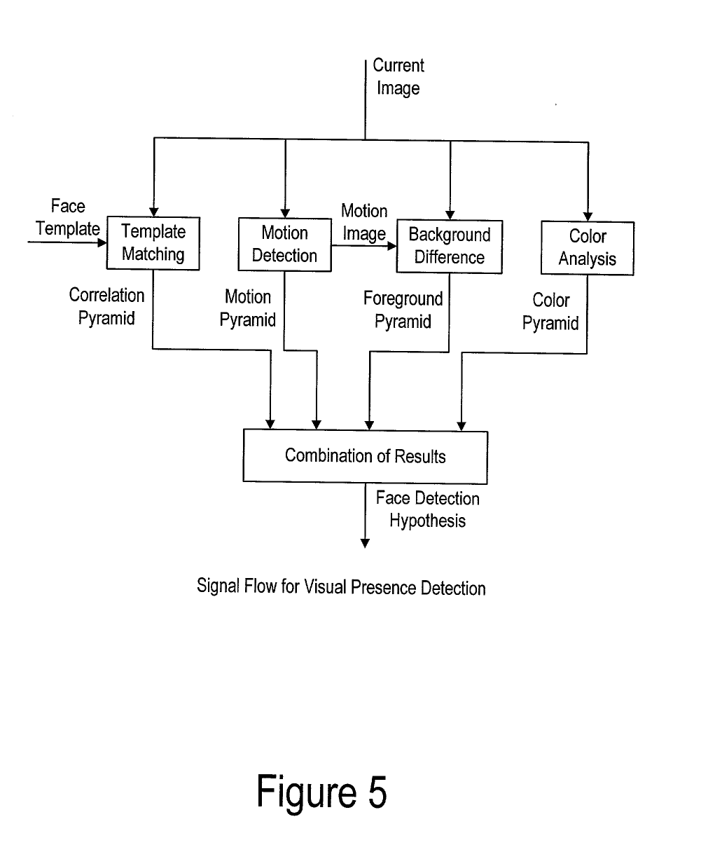

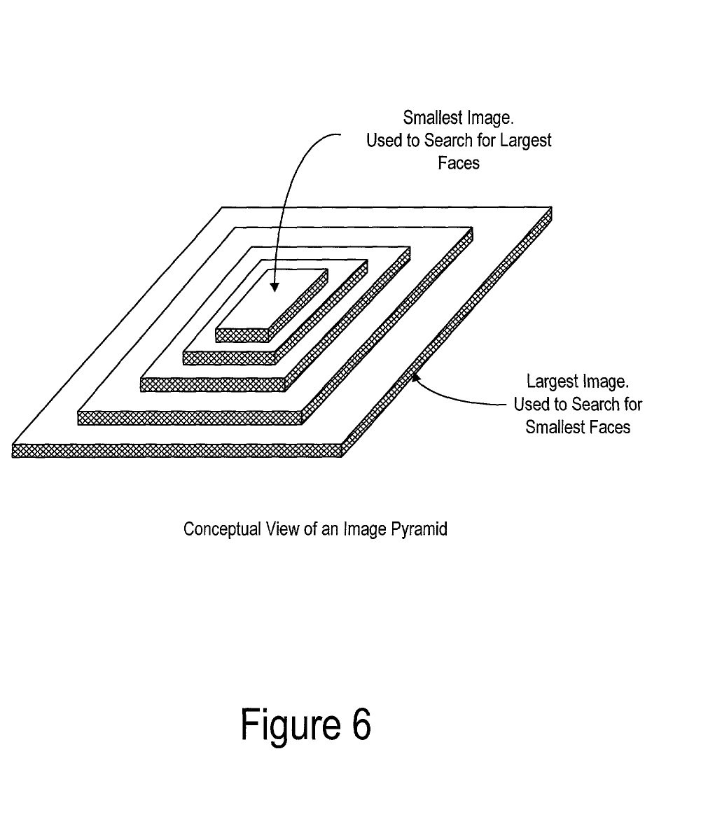

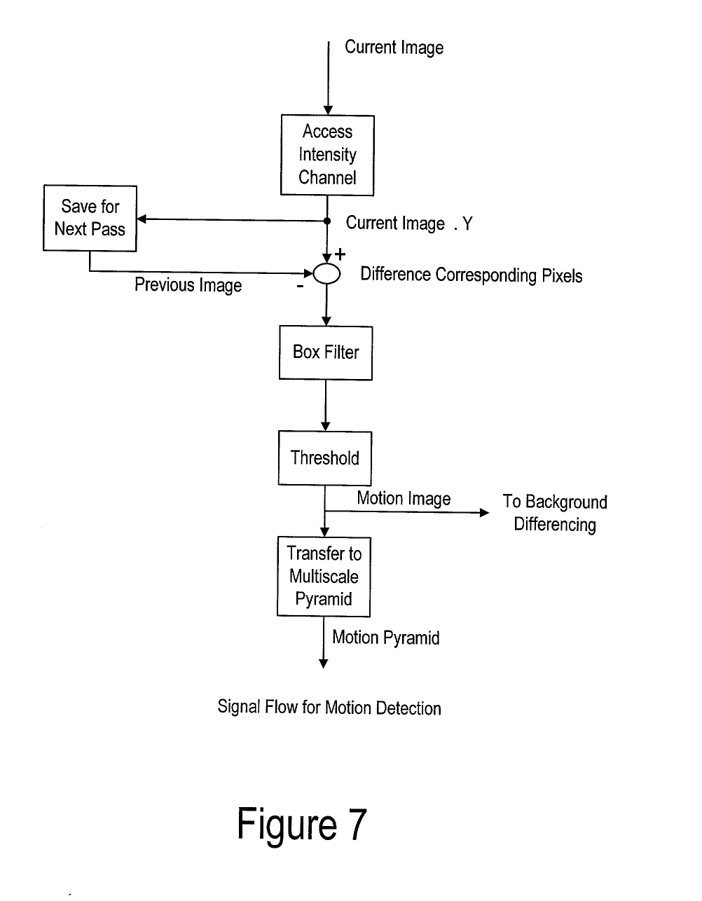

Referring now to FIG. 1, a system for providing security against unwanted viewing of information being displayed on a video terminal of a computer workstation 10, the computer workstation including an input device such as a keyboard 19 or a mouse 20, the system including: a camera 17, responsive to the presence of any user of the computer workstation, the camera for providing from time to time a camera image suitable for indicating whether at the time a user is viewing the video terminal; a guard module 11, hosted by the workstation, responsive to the camera image, and further responsive to a notice of activity on an input device 19 20, the notice provided by the operating system 21 of the workstation, for providing in pre-determined cases a command to the operating system to open a covering window and to display on the video terminal the covering window as the active window, the covering window of sufficient size to cover substantially all of the information bearing regions being displayed on the video terminal; wherein the pre-determined cases include a case in which the camera image indicates that no user is present at the workstation and there is no activity on any input device, and a case in which the camera image indicates that although a user is present at the workstation, the user is not looking at the video terminal, such as when a user has turned away from the video terminal to talk to a passerby, and there is no input activity.

Still referring to FIG. 1, the guard module includes: a detect any face module 14, responsive to the camera image, also responsive to detection algorithm parameters for indicating a threshold used to determine whether a user is viewing the video terminal, and further responsive to detection algorithm parameter, for determining whether a user is viewing the video terminal and for providing a corresponding indicator indicating whether a user is viewing the video terminal; a detect input device activity module 12, responsive to the notice of activity on an input device, for providing an indication of whether a user is using an input device; an adapt sensitivity control module 13, for adapting the detection algorithm parameters to conditions making detecting a face difficult, such as poor lighting conditions, responsive to the indicator indicating whether a user is viewing the video terminal, and further responsive to an indication from the detect any face module whether a user is viewing the video terminal, for providing detection algorithm parameters; and a control covering window module 15, responsive to the indicator indicating whether a user is viewing the video terminal, and further responsive to the indication of whether a user is using an input device, for providing the command to the operating system to open a covering window in case the system determines that no user is viewing the video terminal and no user is using an input device.

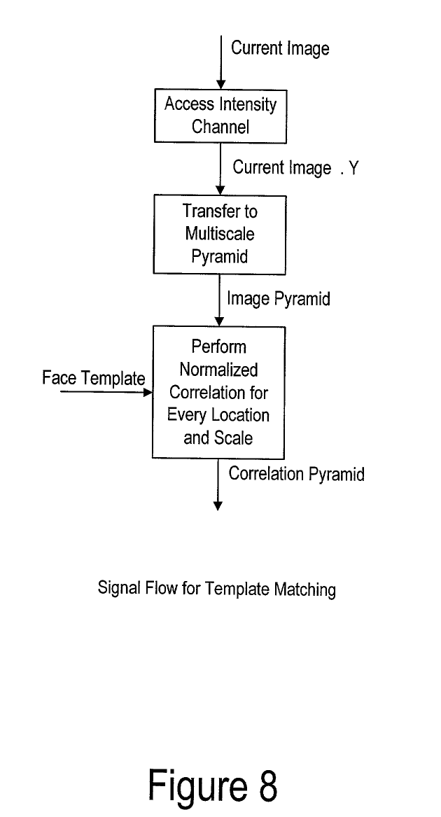

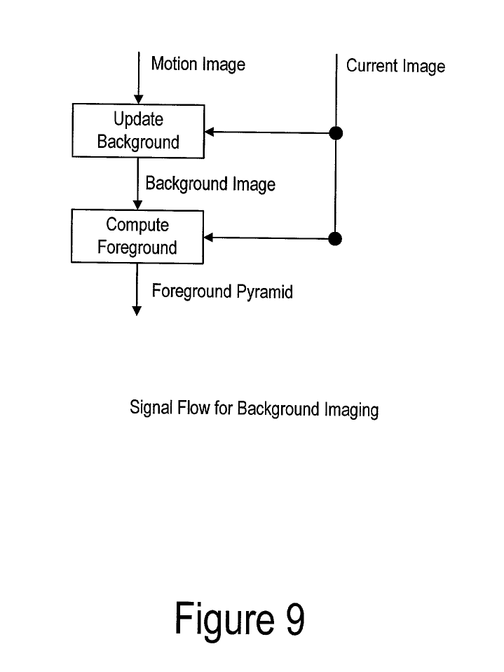

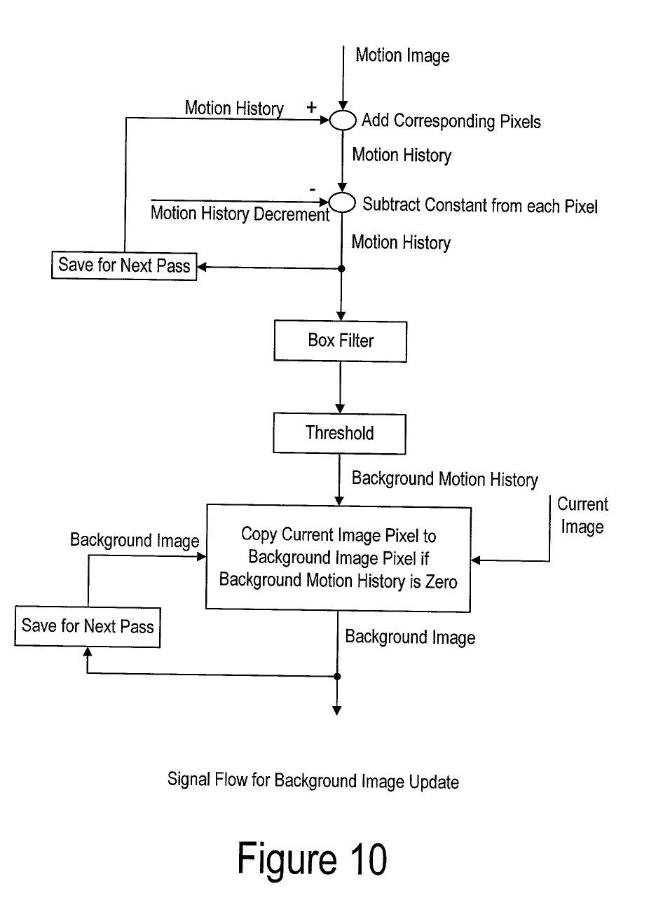

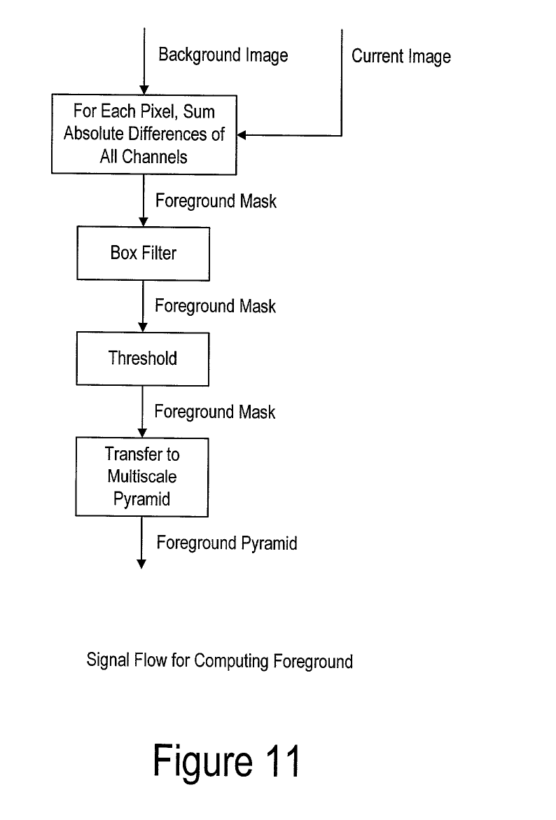

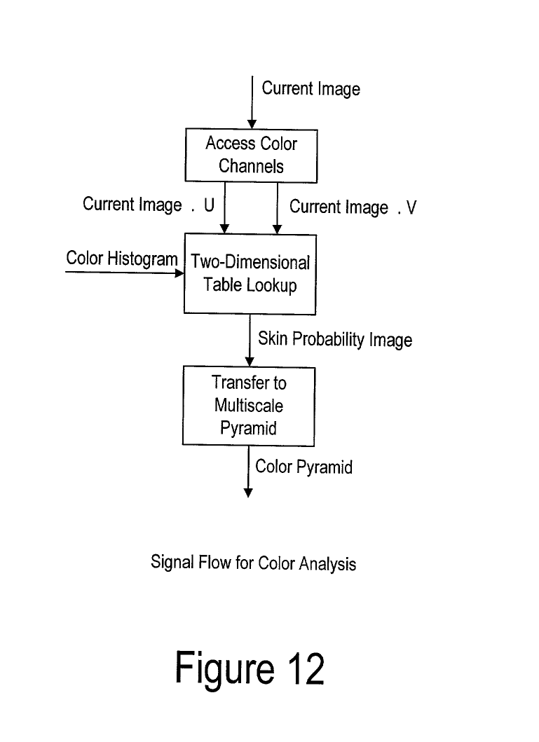

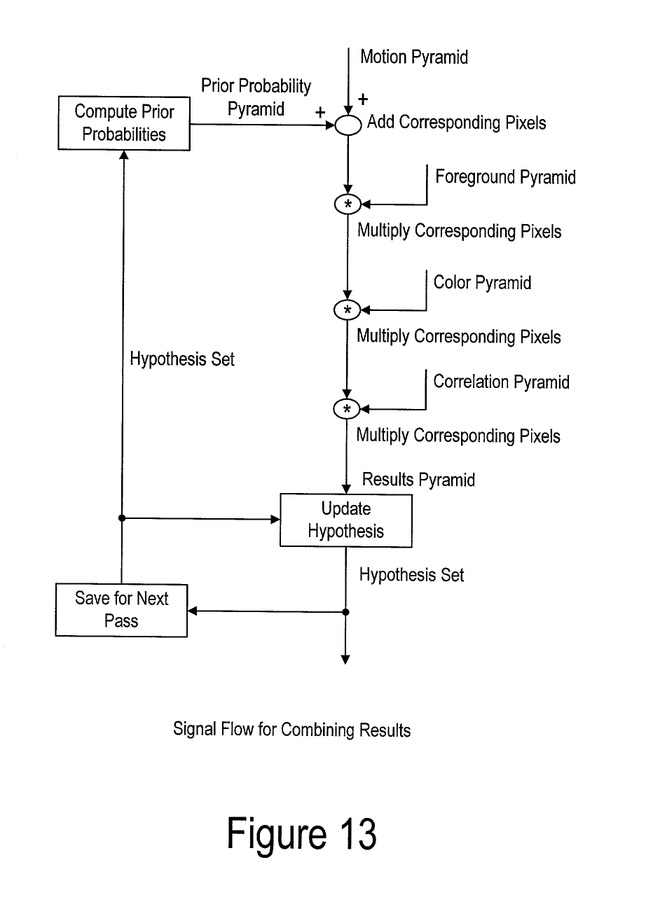

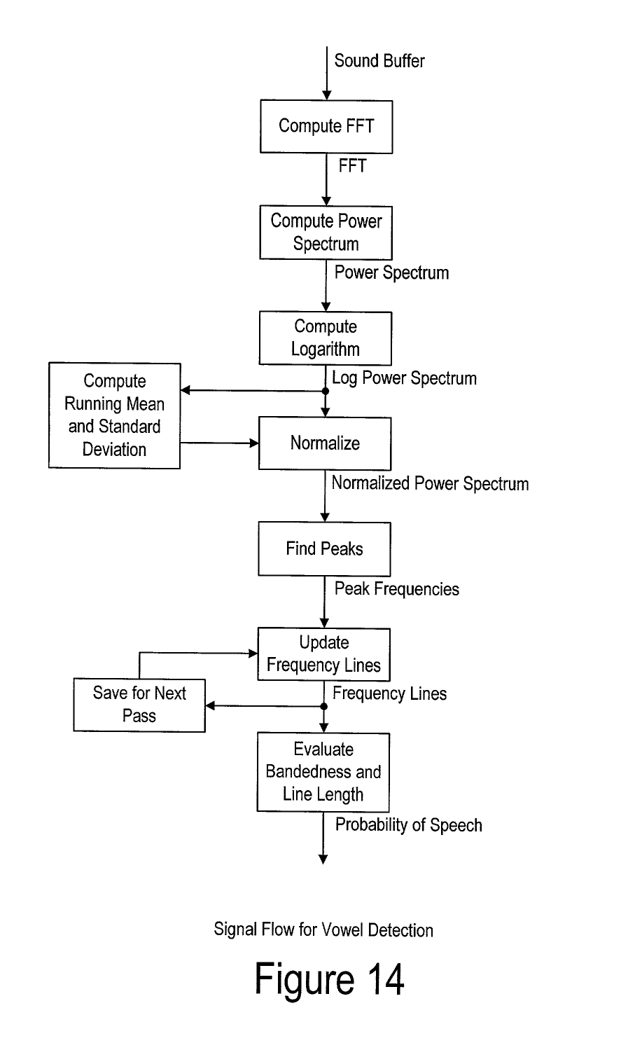

Referring now to FIG. 2, a state transition diagram indicating the operation of a guard system according to the present invention is shown. The notation “!X” is used to indicate “not condition X”.

A key technology that enables this invention is human face detection by analyzing a video stream from a camera focused on the area of interest. The system uses a combination of template matching, motion detection, background differencing, and color analysis to detect a human face in the video stream. Each of these methods will be described in detail below. The signal flow of visual presence detection is illustrated in FIG. 5. The methods are performed by respective subroutines which operate on a common set of data structures stored in random access memory under a series of variable names including currentImage, motionImage, motionPyramid, correlationPyramid, foreground Pyramid, and colorPyramid. The arrival of a new frame of video (currentImage) triggers a processing pass through these subroutines. The results of a processing pass are stored in a set of face detection hypotheses. Each hypothesis consists of a location and scale for a possible face image and a probability number indicating the likelihood that a face of that size is located at that location.

Video Acquisition

The first step in visual detection is to acquire the image stream. In the preferred embodiment, a stream of images is gathered using an inexpensive camera attached to the Universal Serial Bus (USB) of a Personal Computer (PC) running the Microsoft Windows 2000 operating system. Standard Windows Driver Model (WDM) methods (Oney 1999) are used to bring individual frames of the video sequence into a storage area, called currentImage, in Random Access Memory when requested by the downstream processing.

The camera driver is configured to deliver the image in YUV format (Mattison, 1994, p. 104). In this format, each pixel of the image is represented by three 8-bit numbers, called channels. The color information is contained in the U and V channels, and the intensity (“black and white”) information is contained in the Y channel.

The processing for visual detection works on the image stream as a continuous flow of information and produces a continuous stream of detection hypotheses. To control the amount of processing resources consumed by this algorithm, a software timer is used to control the number of frames per second that are fed from the camera. Typically, 15 frames per second are processed.

Template Matching

FIG. 8 shows the signal flow for template matching. Template matching involves searching the intensity channel of the image for a section (patch) that is similar to a reference image (template) of the same size. The template represents the expected appearance of the object being sought. A number of templates may be used to represent all of the variations in appearance of the object. To search for a face, templates that represent the range of appearance of the types of faces sought are used. To minimize the computational load, the preferred embodiment uses a single template derived by averaging a large population of face images. If desired, greater detection accuracy can be achieved at the cost of a greater computational load by using multiple templates. Furthermore, the detection algorithm can be tuned to recognize a particular user by selecting templates that match the range of appearance of that user.

The degree of similarity of the patch to the template is measured by the normalized cross-correlation of their intensities (Haralick and Shapiro, 1993, p.317; Jain, Kasturi, and Schunck, 1995, p. 482; Russ, 1995, p. 342). To implement normalized correlation, first the template is normalized to have zero mean and unit variance. That is, the mean of the all the pixels in the template is computed and subtracted from every pixel, and then the square root of the variance of the pixels is computed and used to divide every pixel. Similarly, the patch is normalized to have zero mean and unit variance. The normalized cross correlation is then computed by averaging the products of the corresponding pixels of the normalized template and the normalized patch. The result will always lie between 1.0 and 1.0, with 1.0 representing a perfect match.

Since the location of the face is initially unknown, the algorithm examines every possible shift of the template relative to the image. The algorithm organizes the results of all of these correlations by storing them in a two-dimensional, floating-point array, which can be thought of as a floating-point image and is called a correlation map. The value stored in particular location of the correlation map is the result of the normalized cross-correlation of the template and a patch centered at the corresponding location of the image.

Because the size of the face image may also vary, a multi-scale search must be performed. This could be accomplished by using several templates of varying sizes; however, a more efficient method is to keep the template size the same and rescale the image. By shrinking the image and keeping the template the same size, the algorithm can search for a larger face in the original image.

To organize this process, the algorithm uses image pyramids. FIG. 6 illustrates the concept of an image pyramid. An image pyramid is a sequence of images where each image is slightly smaller than the previous one in the sequence. It is called a pyramid because, if you imagine the images as being stacked on top of one another, they would look like a pyramid. Each image in the pyramid is called a layer.

Usually, the ratio of dimensions of one layer of the pyramid to those of the previous layer is a constant value. In the preferred embodiment, this ratio is 0.9. In conjunction with this ratio, the number of layers in the pyramid determines the range of face sizes that can be found with a single template. The preferred embodiment uses seven layers. This supports searching for face sizes that can vary by as much as a factor of two.

To search for faces of varying sizes, the algorithm maps the intensity values (Y channel) of the incoming image onto a pyramid of smaller images. Call this pyramid inputPyramid. The algorithm computes the value for a pixel (target pixel) in one of the layers of inputPyramid (target layer) by averaging pixels in a rectangle in the incoming image. The dimensions of this averaging rectangle are determined by the ratio of the dimensions of the incoming image to the corresponding dimensions of the target layer. The center of the averaging rectangle is determined by scaling the coordinates of the target pixel by these same dimension ratios.

Next, the algorithm uses the template to compute the correlation map for each layer. These correlation maps are stored in a floating-point image pyramid called correlationPyramid. The number of layers in correlationPyramid is the same as in inputPyramid, and the dimensions of corresponding layers in these two pyramids match.

The result of these calculations is an “image” pyramid, correlationPyramid, where each pixel in the corresponds to the similarity the template to a patch of a particular size (scale) and at a particular location in the input image. A value near 1.0 indicates that a face is likely to be at that scale and location.

Motion Detection

FIG. 7 illustrates the signal flow for motion detection. To support both motion detection and background differencing, the algorithm computes the absolute value of the difference between corresponding pixels of the Y channel of currentImage and previousImage, an 8-bit image which stores the Y channel of image from the previous pass. The results are stored in an 8 bit image called motionImage. (On the initial pass, motionImage is simply set to all zeros.) After computing the difference, the Y channel of currentImage is copied to previousImage.

A box filter (explained in the next sentence) is applied to motionImage to fill in holes which result from areas of the face that did not change significantly from frame to frame. A box filter is a neighborhood averaging method (Russ, 1995, p. 155) that modifies an image by replacing each pixel value with the average of all pixels in a rectangle (box) surrounding it. The preferred embodiment uses a 5 by 5 box.

To eliminate spurious noise, a threshold operation is applied to motionImage. In other words, any pixel below a specified threshold is set to zero and any pixel above the threshold is set to 255. The preferred embodiment uses a threshold of 20.

To facilitate later combination with other results, the algorithm builds an image pyramid, called motionPyramid, from motionImage. This pyramid has the same number of layers and dimensions as correlationPyramid. The same averaging scheme used to build inputPyramid (described above) is used to build motionPyramid from motionImage.

The result of these operations is an “image” pyramid, motionPyramid, where each pixel in the pyramid is a number between zero and 255. The value indicates how much motion is near the corresponding point in the incoming image. A value of zero indicates that there is no significant motion nearby.

Background Differencing

The signal flow for background differencing is shown in FIG. 9. As shown in this illustration, background differencing consists of two subprocesses: updating the background and computing the foreground.

The signal flow for these background updating is shown in FIG. 10. To update the background, the algorithm firsts computes a motionHistory image. This is an 8-bit image where each pixel value indicates how long it has been since there was motion at that location. The motionHistory image is initialized to zero at program startup. On each pass, motionImage is added to it, using saturation arithmetic. (Saturation arithmetic avoids overflow and underflow in integer operations. In the case of 8 bit unsigned integers, saturation arithmetic limits the result to be no larger than 255 and no smaller than zero. For example, if 150 and 130 are added, the result is limited to 255. Without saturation arithmetic, adding 150 and 130 would produce overflow and the result would be 24.)

The memory of the motion is decayed by decrementing each pixel of motionHistory by a value of motionHistoryDecrement once every motionHistorySkip frames. The amount and frequency of the decrement determines how fast the motion history will decay; a larger value of motionHistoryDecrement and a smaller value of motionHistorySkip produces a faster decay. In the preferred embodiment, motionHistoryDecrement is set to one and motionHistorySkip is set to four, which means that the motion history will decay to zero after 1020 frames (68 seconds). This means motion more than 68 seconds ago ceases to influence the algorithm.

To update the background image, the algorithm copies motionHistory into another 8-bit image, backgroundMotionHistory, which is then blurred using a box filter. The preferred embodiment uses a 20 by 20 box filter. Then a threshold operation (with a threshold of one) is applied to set all pixels of backgroundMotionHistory to 255 unless there has been no motion near them during the decay period.

If a pixel of backgroundMotionHistory is zero, it indicates that there has been no motion near it for a significant amount of time. In the preferred embodiment, a pixel in backgroundMotionHistory will be zero only if there has been no motion within 10 pixels of it during the last 68 seconds. In this case, all three channels of the pixel at this location in currentImage are copied into the 8-bit Yuv image, backgroundImage.

Next the foreground image is computed as illustrated in FIG. 11. For each pixel in currentImage, the absolute value of the difference of each channel (Y, U, and V) with the corresponding channel of backgroundImage is computed and they are all summed to produce a total absolute difference. As before, saturation arithmetic is used to avoid overflow problems. These results are stored in the corresponding pixel location of an image called foregroundMask. Next a 10 by 10 box filter is applied to foregroundMask to smooth out any noise effects. Then a threshold operation is applied to foregroundMask. As a result of these operations, each pixel in the resulting image, foregroundMask, will be set to 255 if there is any significant difference between backgroundImage and currentImage at within 10 pixels of that location and will be set to zero otherwise. The preferred embodiment uses a threshold of 20 to establish what is a significant difference.

To facilitate later combination with other results, the algorithm builds an image pyramid, called foregroundPyramid, from foregroundMask. This pyramid has the same number of layers and dimensions as correlationPyramid. The same averaging scheme used to build inputPyramid (described above) is used to build foregroundPyramid from foregroundMask.

The result of these calculations is an “image” pyramid, foregroundPyramid, where each pixel is a number between zero and 255. The value indicates how many foreground (non-background) pixels are near the corresponding point in the incoming image. A value of zero indicates that only background pixels are nearby.

Color Analysis

Performing color analysis involves determining for each pixel in the current image the likelihood that it is the color of human skin. FIG. 12 illustrates the process. Since only the U and V channels in currentImage contain color information, only these channels need to be examined. In this implementation, the 8-bit values for U and V are used to index into a 256 by 256 array to look up the likelihood that that combination of U and V represents skin. This lookup table, which is called colorHistogram, is represented by an 8-bit deep, 256 by 256 image. For each pixel in currentImage, its U value is used as the row index and its V value is used as the column index to lookup the likelihood that the pixel represents skin. This likelihood, which is represented by a number between zero and 255, is then placed in the corresponding pixel location of the result, skinProbabilityImage.

Once again, to facilitate later combination with other results, the algorithm builds an image pyramid, called in this case colorPyramid, from motionImage. The same averaging scheme used to build inputPyramid (described above) is used to build colorPyramid from skinProbabilityImage. This pyramid has the same number of layers and dimensions as correlationPyramid.

The result of these operations is an “image” pyramid, colorPyramid, where each pixel is a number between zero and 255. The value indicates how much skin color is near the corresponding point in the incoming image. A value of zero indicates that there is no skin color nearby.

The lookup table for skin probability, colorHistogram, can be set to a default table or can be “trained” during use, i.e. the computer can be trained to assign a higher probability to sensed values which are close to the skin tones of the computer's regular user or users. A menu selection allows the user to bring up a window showing the live video. The user can then click on an area of skin in the image. The values of U and V, call them uᵣ and vᵣ, are extracted from the pixel that was clicked on and used to modify the lookup table by adding exp{−((u−ur)²+(v−vᵣ)²)/(2*d²)} to the value in the corresponding (u, v) location of the table using saturation arithmetic. The assumption is that colors near the color of the selected point are like to also be skin. A Gaussian form is used, somewhat arbitrarily, to express this assumption. In the preferred embodiment, the value of d is chosen to be 2.

Combination of Results

Figure K shows the method used to combine all of the previous results. The algorithm combines the quantities calculated in the previous steps in a fairly simple manner and stores the results in a pyramid, resultsPyramid, which is the same size as all of the others. This pyramid is searched for likely face detections, which are stored in a set of hypotheses. Each hypothesis contains a location, a scale, and a probability number. The probability of having detected a face is taken be the largest of these probability numbers.

Since the frame rate of processing is relatively high, if a face was found in the previous frame, it is likely that a face will be found at a nearby location and scale in the current frame. Therefore, there is value in carrying information from one pass to the next. This is done by means of a prior probability pyramid, priorPyramid. This pyramid has the same number of layers and the same dimensions as all of the other pyramids. A pixel in a layer of this pyramid represents the probability that a face may be at the corresponding location and scale based only on what was found in the previous frame. The method for computing the pixel values of this pyramid will be explained below, after the combination method is described.

The first step in the combination process is to add corresponding pixels of priorPyramid and motionPyramid and to store the result in the corresponding pixel of resultsPyramid. At this point, a pixel in resultsPyramid represents the probability that there is a face at that particular location and scale based having either seen a face nearby on the last pass or on having seen nearby motion on this pass.

Next corresponding pixels in resultsPyramid, colorPyramid and correlationPyramid, are all multiplied together and stored back in resultsPyramid. After this operation, a pixel in resultsPyramid represents the probability that a face is at that location and scale, based on all available information. Since the values are stored as 8-bit unsigned integers, they range from zero to 255. A value near 255 represents a high probabilitity that there is a face at the corresponding location and scale in the incoming image.

This method of combination reduces the number of false matches. To indicate the presence of a face at a particular location and scale, there must be (1) either significant motion near the location or a previous sighting of a face at that location and scale, (2) significant difference from the background (pixels that have not changed for 68 seconds), (3) a significant amount of skin color near the location, and (4) a large positive correlation with the face template.

At this point, the algorithm could find all faces in the image by exhaustively searching resultsPyramid for all locations that represent high probabilities. However, since an exhaustive search would be very expensive, a randomized search method is used. To implement the randomized search, a number of hypotheses are maintained from pass to pass. Each hypothesis has a location and scale and will be assigned a probability number representing the likelihood that there is a face at this location and scale. At program startup, the location and scale values are chosen randomly and the probability is set to zero. At the end of each pass, these numbers are updated as follows. The algorithm searches resultsPyramid for a maximum in a limited neighborhood around the location and scale that the hypothesis had on the last pass. If this maximum, which represents the probability of a face, is above a threshold (typically 0.6) then the hypothesis takes on the location and scale where this maximum was found and the probability is retained. Otherwise, the new location and scale for the hypothesis are chosen randomly and the probability is set to zero.

Because the algorithm operates at a relatively high frame rate (typically 15 frames per second) and a fairly large number of hypotheses are used (typically 20 or more), the algorithm can locate a face after only a few frames of video. This approach allows the algorithm the flexibility to locate several faces in the image with a reasonably small computational load.

At the end of the pass, the hypotheses with non-zero probabilities are used to compute the prior probability pyramid for the next pass. First, all pixels in priorPyramid are set to zero. Then for each of these hypotheses, a probability distribution is added to priorPyramid around the location and scale of that hypothesis. In the preferred embodiment, a Gaussian distribution is used.

It is to be understood that the above-described arrangements are only illustrative of the application of the principles of the present invention. Numerous other modifications and alternative arrangements may be devised by those skilled in the art without departing from the spirit and scope of the present invention, and the appended claims are intended to cover such modifications and arrangements.

### REFERENCES

Haralick and Shapiro, 1993—Robert M. Haralick and Linda G. Shapiro, “Computer and Robot Vision”, Volume II, Addison-Wesley Publishing Company, Inc., Reading, Mass., 1993.

Jain, Kasturi, and Schunck, 1995—Ramesh Jain, Rangachar Kasturi, and Brian G. Schunck, “Machine Vision”, McGraw-Hill, Inc., New York, N.Y., 1995.

Mattison, 1994—Phillip E. Mattison, “Practical Digital Video with Programming Examples in C”, John Wiley & Sons, Inc., New York, N.Y., 1994.

Oney, 1999—Walter Oney, “Programming the Microsoft Windows Driver Model”, Microsoft Press, Redmond, Wash., 1999.

Russ, 1995—John C. Russ, “The Image Processing Handbook”, Second Edition, CRC Press, Boca Raton, Fla., 1995.

What is claimed is:

1. A system for providing security against unwanted viewing of information being displayed on a video terminal of a computer workstation, the computer workstation including an input device such as a keyboard, the system comprising:
a) a camera, responsive to the presence of any user of the computer workstation, the camera for providing from time to time a camera image suitable for indicating whether at the time a user is viewing the video terminal;
b) a guard module, hosted by the workstation, responsive to the camera image, and further responsive to a notice of activity on an input device, the notice provided by the operating system of the workstation, for providing in predetermined cases a command to the operating system to open a covering window and to display on the video terminal the covering window as the active window, the covering window of sufficient size to cover substantially all of the information bearing regions being displayed on the video terminal;
wherein the pre-determined cases include a case in which the camera image indicates that no user is present at the workstation and there is no activity on any input device, and a case in which the camera image indicates that although a user is present at the workstation, the user is not looking at the video terminal, such as when a user has turned away from the video terminal to talk to a passerby, and there is no input activity.

2. The system of claim 1, wherein the guard module comprises:
a) a detect any face module, responsive to the camera image, also responsive to detection algorithm parameters for indicating a threshold used to determine whether a user is viewing the video terminal, and further responsive to detection algorithm parameter, for determining whether a user is viewing the video terminal and for providing a corresponding indicator indicating whether a user is viewing the video terminal;
b) a detect input device activity module, responsive to the notice of activity on an input device, for providing an indication of whether a user is using an input device;
c) an adapt sensitivity control module, for adapting the detection algorithm parameters to conditions making detecting a face difficult, such as poor lighting conditions, responsive to the indicator indicating whether a user is viewing the video terminal, and further responsive to an indication from the detect any face module whether a user is viewing the video terminal, for providing detection algorithm parameters;
d) a control covering window module, responsive to the indicator indicating whether a user is viewing the video terminal, and further responsive to the indication of whether a user is using an input device, for providing the command to the operating system to open a covering window in case the system determines that no user is viewing the video terminal and no user is using an input device.

3. A method for providing security against unwanted viewing of information being displayed on a video terminal of a computer workstation, the computer workstation including an input device such as a keyboard, the method comprising the steps of:
a) providing from time to time a camera image suitable for indicating whether at the time a user is viewing the video terminal;
b) determining whether a user is viewing the video terminal using a detection algorithm with parameters adapted to conditions making such a determination difficult;
c) determining whether a user is using an input device;
d) adapting the detection algorithm parameters based on an initial determination of whether a user is viewing the video terminal and on whether a user is using an input device; and
e) providing in pre-determined cases a command to the operating system to open a covering window and to display on the video terminal the covering window as the active window, the covering window of sufficient size to cover substantially all of the information bearing regions being displayed on the video terminal;
wherein the pre-determined cases include a case in which the camera image indicates that no user is present at the workstation and there is no activity on any input device, and a case in which the camera image indicates that although a user is present at the workstation, the user is not looking at the video terminal, such as when a user has turned away from the video terminal to talk to a passerby, and there is no input activity.
